(19) United States
(12) Patent Application Publication
(10) Pub. No.: US 2024/0309833 A1
(43) Pub. Date: Sep. 19, 2024

(54) IMPROVING FUEL ECONOMY WITH MINIMUM EMISSION IN HEAVY DIESEL ENGINES

(71) Applicant: Mukesh Kumar VIDYARTHI, Haldwani (IN)

(72) Inventor: Mukesh Kumar VIDYARTHI, Haldwani (IN)

(21) Appl. No.: 18/546,838

(22) PCT Filed: Feb. 16, 2022
(86) PCT No.: PCT/IN2022/050134

§ 371 Date: Aug. 17, 2023

(30) Foreign Application Priority Data
Feb. 17, 2021 (IN) 202111006556

(51) Int. Cl. F02M 27/04; F02M 26/15; F02M 26/23

(52) U.S. Cl. CPC F02M 27/04; F02M 26/15; F02M 26/23

(57) ABSTRACT

Disclosed is an arrangement for charging polarized atmospheric air (4) and polarized exhaust gas (7) simultaneously in internal combustion diesel engine (1) comprising of at least two polarizing cum filter mesh arrangement consisting of an inlet end and an outlet end; a cylindrical pipe; a plurality of pair of meshed discs as electrodes, insulating glasses; nylon rubber; a hose pipe (3,5) and a circuitry for providing DC power to the mesh disc electrodes; wherein said one polarizing cum filter mesh arrangement is (4) connected at outlet of intercooler (6) and inlet of the internal combustion engine for charging polarized atmospheric air to said engine and another said polarizing cum filter mesh arrangement is connected between the exhaust end of the internal combustion diesel engine and outlet of the inter cooler for charging polarized exhaust gases again back to the said internal combustion diesel engine through said intercooler.

### FIELD OF INVENTION

The present disclosure relates to an arrangement for charging polarized atmospheric air and polarized exhaust gas simultaneously in an internal combustion diesel engine and the method thereof. More particularly, the present invention discloses an arrangement for improving the overall efficiency of a diesel engine, by recirculating high pressure exhaust gas (burnt gas) along with fresh polarized air into a diesel engine through intercooler in order to burn the diesel/fuel completely and sedimenting the pollutants thereby increasing the efficiency, power and reducing pollution.

### BACKGROUND ART

Exhaust-gas recirculation systems serve in particular for reducing the toxic emissions. Conventionally, many vehicles are equipped with a turbocharger for the purpose of improving engine output, and an exhaust gas recirculation device is also attached to a turbocharged engine equipped with a turbocharger.

The Exhaust-gas recirculation of the turbocharged engine is performed using the pressure difference from the upstream side of the turbocharger turbine to the downstream side of the compressor. In the turbocharged engine, the supply air pressure is higher than the exhaust pressure. There is an operation region (especially a low speed and high load region), and there is a possibility that EGR cannot be sufficiently performed in this operation region.

Therefore, as an exhaust gas recirculation device for a turbocharged engine that solves such problems and enables Exhaust-gas recirculation even in a high load range, those disclosed in prior art documents as mentioned below.

In the prior art, a German document DE 10 2008 043 802 A1 describes a device for recalculating exhaust gas in an internal combustion engine, comprising an exhaust gas recirculation line and a humidifier, which is arranged in the exhaust gas recirculation line to cool the exhaust gas to be supplied to the internal combustion engine and to humidify at the same time.

In another prior art a German document DE 10 2008 056 337 A1 discloses an internal combustion engine, in particular a diesel engine or a gasoline engine, with a fresh air system and an exhaust system. In the fresh air system while a charge air cooler is arranged, and in the exhaust system, at least one exhaust gas turbocharger is arranged. The exhaust gas turbocharger has a compressor arranged in the fresh air system downstream of the charge air cooler and a turbine arranged in the exhaust gas system. A high-pressure exhaust gas recirculation line branches off the exhaust gas system upstream of the turbine of the exhaust gas turbocharger, comprises a high-pressure exhaust gas recirculation valve and opens into the fresh air system downstream of the charge air cooler. A low-pressure exhaust gas recirculation line branches off from the exhaust system downstream of the exhaust gas turbocharger, has a low-pressure exhaust gas recirculation valve and opens into the fresh air system upstream of the compressor of the exhaust gas turbocharger. The known internal combustion engine has an exhaust gas damper, which is arranged in the exhaust system downstream of the branch of the low-pressure exhaust gas recirculation line. Further, a charge air cooler bypass bypassing the intercooler is arranged in the fresh air system of the internal combustion engine.

In yet another prior art a Japanese document JP 2010-025034 describes an exhaust gas recirculation device for an internal combustion engine, which connects a section between an exhaust system and a fresh air system of the internal combustion engine by means of an exhaust pipe, which comprises an exhaust gas cooler and an exhaust valve. The exhaust device has a sump for collecting condensed water. The exhaust device further includes a condensation water supply device that supplies condensation water stored in the header tank downstream of the exhaust gas recirculation valve to the fresh air system.

Another US document US 2011/0094219 A1 describes a method for an intercooler coupled to an internal combustion engine wherein condensate is collected in a condensate collector according to the method. In a first operating state of the internal combustion engine, the condensate is temporarily stored in the condensate collecting device and discharged in a second operating state in a discharge line. The first operating state may in particular be a full-load operation of the internal combustion engine, the condensate being released after the temporary storage. In contrast, the second operating state can be a partial load operation of the internal combustion engine.

In conventional internal combustion engines, especially in diesel engines or gasoline engines, it is known to reduce the emission of exhaust gases of the internal combustion engine, the consumption of the internal combustion engine and also the thermal load of the internal combustion engine by means of an exhaust gas recirculation. A working in a so-called full load exhaust recirculation can thereby significantly reduce a temperature of the exhaust gas, which on the one hand, the need for separate cooling, for example via enrichment, at least reduced, and further opens up the possibility by using cost-effective materials, especially in a turbocharger system for the Internal combustion engine to reduce the cost of their production. In full-load operation, the exhaust gas recirculation must be cooled in order to reduce the tendency of the internal combustion engine to knock. In part-load operation, on the other hand, it may be sensible to initiate the exhaust gases recalculated by means of the exhaust gas recirculation uncooled, since in this way the internal combustion engine can be dethrottled and a combustion speed increased in the combustion of a fuel-air mixture in the internal combustion engine, which is favorable can affect the fuel consumption of the internal combustion engine.

The present invention has been devised in view of such circumstances, and solves the above-described problems, and the exhaust gas recirculation of a turbocharged engine that can perform exhaust gas recirculation reliably even under high supercharging by a turbocharger.

### OBJECT OF INVENTION

Therefore the principle object of the invention is to Increase output Power of the diesel Engine Vehicle@Zero Load 21.36%; @Higher Load 0.68% and Reduce Emission more than 50% for every diesel engine vehicle and reduce the temperature of Environment which is caused by Every Diesel Engine exhaust.

It is an objective of the invention to increase twisting force of the piston connecting rod of Every Diesel Engine Vehicle.

It is an objective of the invention to improve the quality of air and exhaust gas while moving into the combustion chamber to burn the fuel thereby ensuring maximum combustion of fuel and sedimenting of particulate matters and recirculating the exhaust gases for repeated and complete combustion.

### SUMMARY OF INVENTION

Therefore such as herein described there is provided an arrangement for charging polarized atmospheric air and polarized exhaust gas simultaneously in an internal combustion diesel engine in order to enhance its efficiency of the said engine such as horse power (H.P), indicating power (IP), brake power (BP) & reduce friction power (FP); indicating main effective pressure (IMEP), brake main effective pressure (BMEP) & air flow.

In an embodiment the said arrangement for charging polarized atmospheric air and polarized exhaust gas simultaneously in internal combustion diesel engine comprising of at least two polarizing cum filter mesh arrangement consisting of an inlet end and an outlet end; a cylindrical pipe; a plurality of pair of meshed discs as electrodes; insulating glasses; nylon rubber; a hose pipe and a circuitry for providing DC power to the mesh disc electrodes; wherein said one polarizing cum filter mesh arrangement is connected at outlet of intercooler and inlet of the internal combustion engine for charging polarized atmospheric air to said engine and another said polarizing cum filter mesh arrangement is connected between the exhaust end of the internal combustion diesel engine and inlet of the inter cooler for charging polarized exhaust gases again back to the said internal combustion diesel engine through said intercooler.

In an embodiment the polarized atmospheric air and polarized exhaust gas simultaneously in internal combustion diesel engine wherein said electronic circuit device being fixed outside the apparatus means to convert an input voltage of the electric source to an output voltage for charging the connected electrodes meshed discs; wherein the said pair meshed discs being arranged with gap between each adjacent disc wherein the each of said adjacent disc being charged with alternative potential; wherein the said insulating material is placed between adjacent meshed discs in such a way that there is no obstruction is air flow through said discs and wherein the current passes through the meshed discs is 0.02-1.0 AMP.

Further in an embodiment the said arrangement for charging polarized atmospheric air and polarized exhaust gas simultaneously in internal combustion diesel engine comprising of at least two polarizing cum filter mesh arrangement consisting of an inlet end and an outlet end; a cylindrical pipe; a plurality of pair of meshed discs as electrodes; insulating glasses; nylon rubber; a hose pipe and a circuitry for providing DC power to the mesh disc electrodes; wherein said one polarizing cum filter mesh arrangement is connected at outlet of intercooler and inlet of the internal combustion engine for charging polarized atmospheric air to said engine and another said polarizing cum filter mesh arrangement is connected between the exhaust end of the internal combustion diesel engine and inlet of the and internal combustion Diesel Engine configured for parallelly charging polarized exhaust gases and polarized atmospheric air from intercooler into internal combustion diesel engine.

### BRIEF DESCRIPTION OF THE ACCOMPANYING DRAWINGS

FIG. 1(a) illustrates the operational block diagram of the arrangement as a first embodiment in accordance with the present invention;

FIG. 1(b) illustrates the operational block diagram of the arrangement as a second embodiment in accordance with the present invention;

FIG. 2 illustrates the mesh arrangement in accordance with the present invention;

FIG. 3(a) illustrates the elbow with mesh (external) of the arrangement in accordance with the present invention;

FIG. 3(b) illustrates the elbow with mesh (internal) of the arrangement in accordance with the present invention;

FIG. 4 illustrates the electric connection for the mesh in accordance with the present invention;

FIG. 5 illustrates the Electronics circuit for the electric connection for the mesh in accordance with the present invention; FIG. 6(a) is a graph illustrating the relation between IP, BP and FP (table I) when the polarizing arrangement is not implemented;

FIG. 6(b) is a graph illustrating the relation between IMEP, BMEP and FMEP (table II) when the polarizing arrangement is not implemented;

FIG. 6(c) is a graph illustrating the Air and Fuel flow (table III) when the polarizing arrangement is not implemented;

FIG. 6(d) is a graph illustrating the Indicative and Brake thermal efficiency, BP and FP (table IV) when the polarizing arrangement is not implemented;

FIG. 6(e) is a graph illustrating the SFC and fuel consumption (table V) when the polarizing arrangement is not implemented;

FIG. 7(a) is a graph illustrating the relation between IP, BP and FP (table VIII) when the polarizing arrangement is implemented in accordance with the present invention;

FIG. 7(b) is a graph illustrating the relation between IMEP, BMEP and FMEP (table IX) when the polarizing arrangement is implemented in accordance with the present invention;

FIG. 7(c) is a graph illustrating the Air and Fuel flow (table X) when the polarizing arrangement is implemented in accordance with the present invention;

FIG. 7(d) is a graph illustrating the Indicative and Brake thermal efficiency, BP and FP (table XI) when the polarizing arrangement is implemented in accordance with the present invention;

FIG. 7(e) is a graph illustrating the SFC and fuel consumption (table XII) when the polarizing arrangement is implemented in accordance with the present invention;

FIG. 8(a) is a graph illustrating the increase in H.P. (table XVI) when the polarizing arrangement is implemented in accordance with the present invention;

FIG. 8(b) is a graph illustrating the increase in SFC (%) (table XVII) when the polarizing arrangement is implemented in accordance with the present invention;

FIG. 8(c) is a graph illustrating the decreasing percentage of smoke (table XIX) when the polarizing arrangement is implemented in accordance with the present invention;

FIG. 8(d) is a graph illustrating the increase in percentage of IP (kW) (table XX) when the polarizing arrangement is implemented in accordance with the present invention;

FIG. 8(e) is a graph illustrating the increase in percentage IMEP (table XXI) when the polarizing arrangement is implemented in accordance with the present invention;

FIG. 8(f) is a graph illustrating the increase in thermal efficiency (table XXII) when the polarizing arrangement is implemented in accordance with the present invention;

FIG. 8(g) is a graph illustrating the increase in volume efficiency (table XXIII) when the polarizing arrangement is implemented in accordance with the present invention.

### DETAILED DESCRIPTION

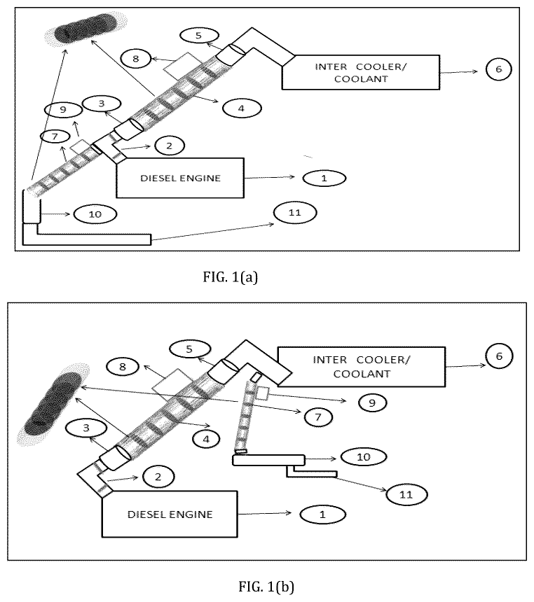

In FIG. 1(a) and (b) an internal combustion engine according to the invention is designated. The internal combustion engine comprises a fresh air system wherein a charge air cooler is arranged. By means of the fresh air system the internal combustion engine can be supplied with fresh air. The internal combustion engine further comprises an exhaust system for the removal of exhaust gas from the internal combustion engine as well as an exhaust gas turbocharger, which has a compressor arranged in the fresh air system upstream of the charge air cooler and a turbine arranged in the exhaust gas system. The internal combustion engine also has a high-pressure exhaust gas recirculation pipe fitted with charged mesh for a total recirculation of exhaust gas from the exhaust gas system into the fresh air system. The high-pressure exhaust gas recirculation pipe branches off upstream of the engine of the exhaust gas turbocharger of the exhaust gas system. The high-pressure exhaust gas recirculation pipe has further a high-pressure exhaust gas recirculation valve and opens into the fresh air system downstream of the charge air cooler at a connection point. In addition to the high-pressure exhaust gas recirculation pipe the internal combustion engine according to the invention also comprises a low-pressure exhaust gas recirculation pipe with an exhaust gas recirculation cooler for the at least partial recirculation of exhaust gas from the exhaust gas system into the fresh air system. The low-pressure exhaust gas recirculation pipe has a low-pressure exhaust gas recirculation valve and opens upstream of the compressor of the exhaust gas turbocharger into the fresh air system.

The present invention provides an arrangement for charging Polarized exhaust gas and atmospheric air in an internal combustion diesel engine to enhance its efficiency such as horse power (H.P) indicating power (IP), brake power (BP) & reduce friction power (FP); indicating main effective pressure (IMEP), air flow.

The different components of the said arrangement are: FIG. 1a and 1b
1=Diesel Engine
2=aluminium alloy Elbow which coated by non-conducting material like Teflon, paint, or made of non-metal.)
3,5=Rubber Hose;
10=EGR Coolant/EGR Filter
4,7=Innovative Apparatus which have pair of copper mesh with suspended at distance of 1.5 mm and distance of each pair of copper mesh is 1 inch to 10 inch. And 4,7 is coated by non-conducting material.
7=apparatus is added between (E.G.R Coolant)/Diesel Engine Exhaust and 6 intercooler end point where fresh air moves to apparatus 4
6=intercooler,
8,9=Electronic circuit.

The different components of the said arrangement are: FIG. 1b
1=Diesel Engine
2=aluminium alloy Elbow which coated by non-conducting material like Teflon, paint, or made of non-metal.)
3,5=Rubber Hose;
10=EGR Coolant/EGR Filter
4,7=Innovative Apparatus which have pair of copper mesh with suspended at distance of 1.5 mm and distance of each pair of copper mesh is 1 inch to 10 inch. And 4,7 is coated by non-conducting material.
7=apparatus is added between (E.G.R Coolant)/Diesel Engine Exhaust and 6 intercooler end point where fresh air moves to apparatus 4
6=intercooler,
8,9=Electronic circuit.

Composition Exhaust gas Compound Present in Diesel Engine Exhaust gas are Nitrogen; Carbon Di Oxide; water vapour; Oxygen; Sulphur di Oxide.

Trace Elements Present in Diesel Engine Exhaust gas-Nitrogen Oxide; Carbon Mono Oxide; Particulate Matter; Smoke; Hydrocarbon; Sulphur Di Oxide.

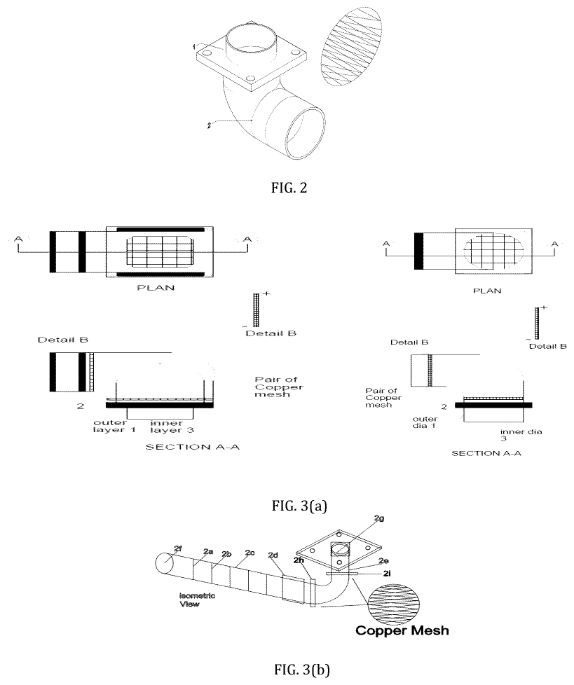

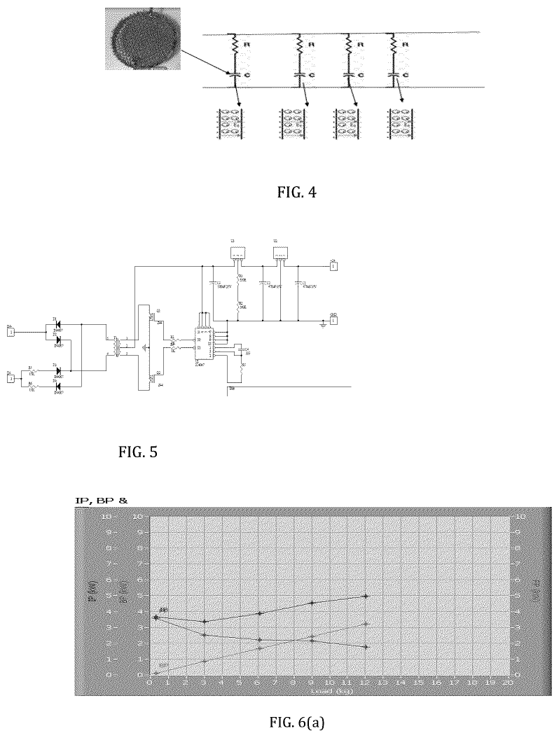

As shown in FIG. 2, there is disclosed an arrangement of pair of copper Mesh suspended by 1 mm at a separation. In order to achieve the aforementioned effects the air according to the present invention is passing through a cylindrical pipe comprising of plural number of a pair of meshed discs being made up of a material selected from group consisting of copper, aluminium and steel alloys. The electrode, cathode (3) and anode (4) accordingly to present invention is alternatively placed.

As shown in FIG. 1, there is provided a polarizing cum filter mesh arrangement, preferably connected at the inlet of the inter cooler consist of an inlet and an outlet; a cylindrical pipe; a plurality of pair of meshed discs; insulating glasses; nylon rubber; a hose pipe and a circuitry for providing DC power to the mesh disc electrodes.

In order to achieve the forced polarized air/exhaust gas supply of the air is passed through a cylindrical pipe comprising of plural number of a pair of meshed discs being made up of a material selected from group consisting of copper, aluminum and steel alloys. The electrode, cathode and anode according to present invention are alternatively placed. The arrangement of the meshed discs in such a way so as to provide a gap between each meshed disc and the each pair. The distance or gap between the above can be varied depending upon the requirement of the charge inside the cylinder, also so can the number of disk pairs. In preferred embodiment, the gap between two meshed discs is 1 mm and the gap between the two pairs is 3 inch. Also, in preferred embodiment, the pair of such mesh discs is 5 and total number of meshed disc is 10. Also, the each meshed disc is separated by insulating material like glasses. Pair of discs mesh according to present invention could also be increased depending upon the distance between the engine and turbocharger.

As shown in FIGS. 2 and 3, there is provided an L-shaped hose pipe which according to present invention is made up of a material which is non-conducting, having low ductile with higher hardness property. The material according to present invention is PVC. The assembly comprises a nylon rubber which is connected to L-shaped hose pipe. L-shaped hose pipe is further connected to a device called as a charge protector before connected to the diesel engine for preventing air discharge. The diameter of this charge protector is according to present invention is equal to the size of the diesel engine intake main ford hole.

The configuration of the charge protector according to present invention is dependent upon the power of diesel engine and air intake manifold d hole. In preferred embodiment, the shape of the charge protector according to present invention is cylindrical shape. The distance between the charge protector and the engine is about 1.5 inch.

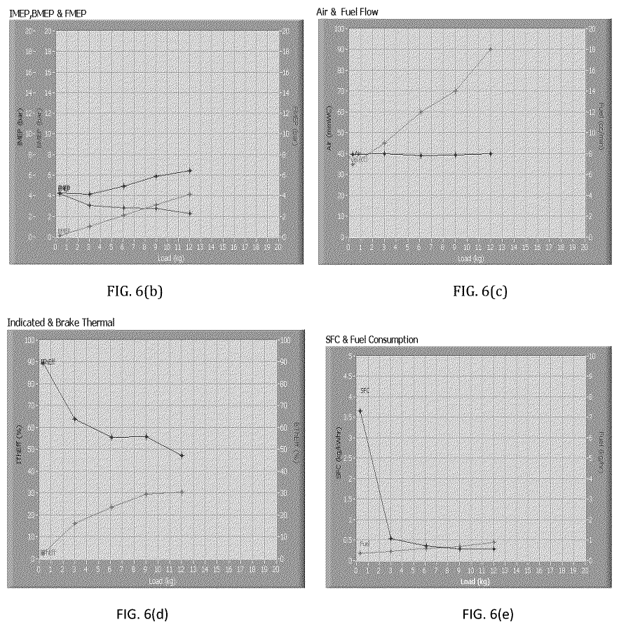

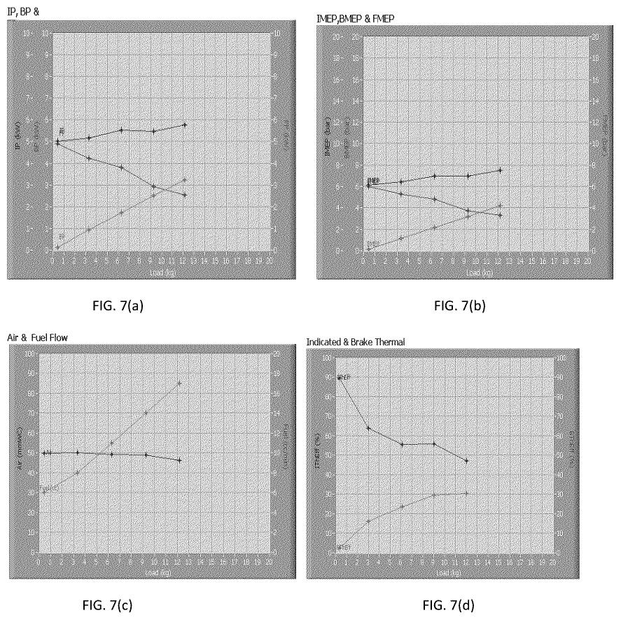

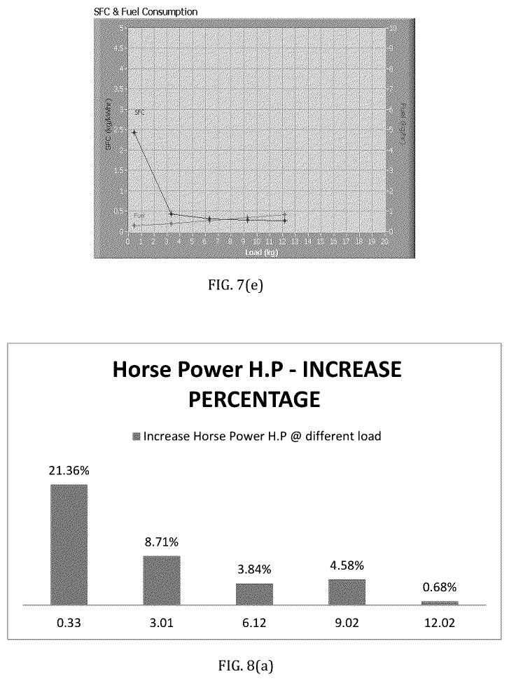

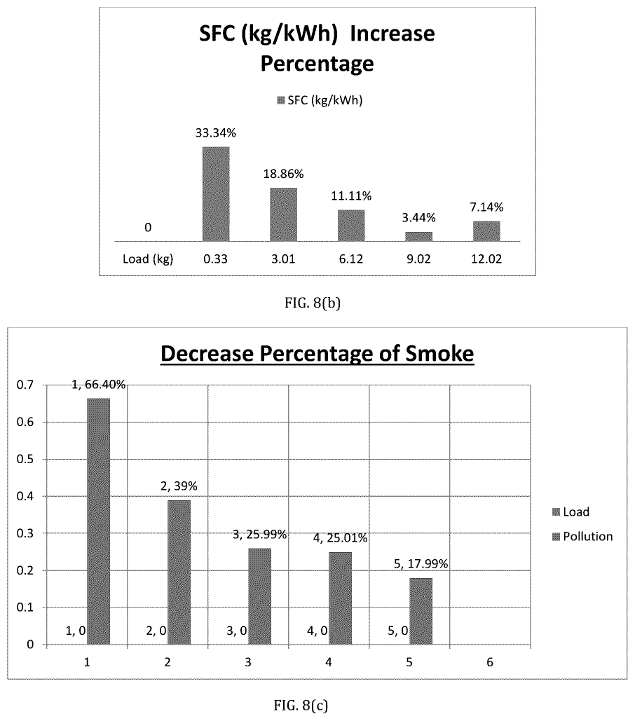

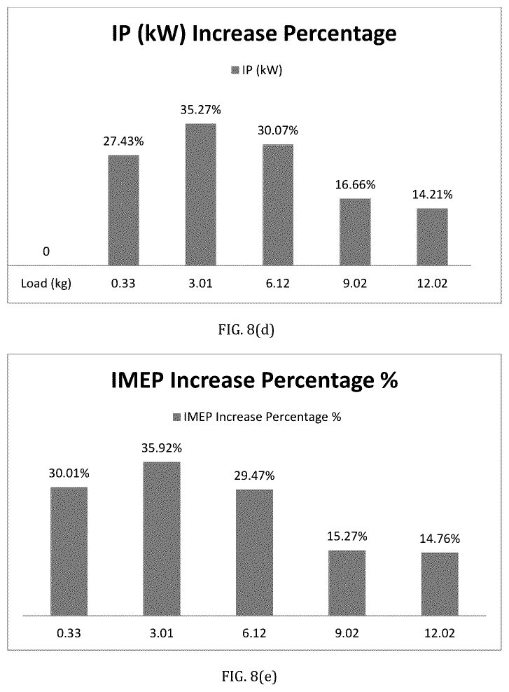

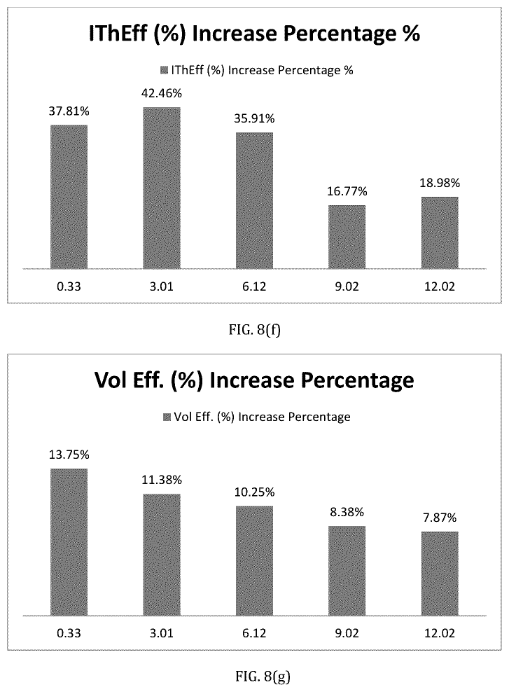

The present invention provides an electronic circuit device (27) being fixed outside the assembly whose one end connected to a voltage or electric source (FIG. 6), is responsible to convert an input voltage of 12V DC of the source to output voltage of 130-250V DC of the meshed discs. The current passes throughout the meshed discs according to present invention is 0.02-1.0 AMP (FIG. 1).

The invention is now illustrated by non-limiting examples:

The arrangement of the meshed discs in such a way so as to provide a gap between each meshed disc (FIG. 3a) and the each pair (FIG. 3b). The distance or gap between the above can be varied depending upon the requirement of the charge inside the cylinder, also so can the number of disk pairs. In preferred embodiment, the gap between two meshed discs is 1 mm and the gap between the two pairs is 3 inch. Also, in preferred embodiment, the pair of such mesh discs is 5 and total number of meshed disc is 10. Also, the each meshed disc is separated by insulating material like glasses.

As shown in FIG. 2, 3, if Diesel Engine Intake manifold hole is circular then then elbow is connected between Diesel Engine and Rubber hose, Elbow includes a pair of copper mesh, these pair of copper mesh have potential of 350 Volt DC at current 0.02 amp. And have an extended circular length, which is less than the diameter of Diesel Engine air intake manifold hole, so that said Elbow can comfortably connect to the Diesel Engine Intake manifold hole.

The exhaust air according to the present invention is passing through a cylindrical pipe comprising of plural number of a pair of meshed discs being made up of a material selected from group consisting of copper, aluminium and steel alloys. The electrodes which in our present case are the adjacent placed mesh, are cathode and anode accordingly to present invention is alternatively placed.

The arrangement of the meshed discs in such a way so as to provide a gap between each meshed disc (FIG. 3a) and the each pair (FIG. 3b). The distance or gap between the above can be varied depending upon the requirement of the charge inside the cylinder, also so can the number of disk pairs. In preferred embodiment, the gap between two meshed discs is 1 mm and the gap between the two pairs is around 3 inches. Also, in preferred embodiment, the pair of such mesh discs is 5 (five) and total number of meshed disc is 10. Also, the each meshed disc is separated by insulating material in corners like glasses. Pair of discs mesh according to present invention could also be increased depending upon the distance between the engine intake, intercooler, turbocharger and exhaust.

As shown in FIG. 3, the present invention presents an L-shaped hose pipe which according to present invention is made up of a material which is non-conducting, having low ductile with higher hardness property. The material according to present invention is PVC. The assembly comprises a nylon rubber which is connected to L-shaped hose pipe. L-shaped hose pipe is further connected to a device called as a charge protector before connected to the diesel engine for preventing air discharge. The diameter of this charge protector is according to present invention is equal to the size of the diesel engine intake main ford hole.

The configuration of the charge protector according to present invention is dependent upon the power of diesel engine and air intake manifold hole. In a preferred embodiment, the shape of the charge protector according to present invention is cylindrical shape. The distance between the charge protector and the engine is about 1.5 inch.

The present invention provides an electronic circuit being fixed outside the assembly whose one end connected to a voltage or electric source (FIG. 5), is responsible to convert an input voltage of 24V DC of the source to output voltage of 250-350V DC of the meshed discs. The current passes throughout the meshed discs according to present invention is 20 mA.

### Components Used for Making Electronics Circuit

IC; Capacitor; MOSFET; Resistance; Diode; Resistance; Transformer; PCB Printed Circuit Board, Heat Sink.

### Electronic Circuit—

Introduction—Our main aim is to generate 350V DC voltage, 20 MA current to activate air molecules in pipe with available battery voltage 24V dc. Thus we have used Inverter and rectifier circuit to convert 24 Vdc into 350V dc voltage.

Inverter is a small circuit which will convert the direct current (DC) to alternating current (AC). The power of a battery is converted in AC power. The main function of the inverter is to convert DC to AC. Rectifier is a circuit which will convert again AC voltage into required DC voltage.

### Circuit Diagram—

In the circuit diagram we can observe that 24V DC battery voltage is given to the Regulator circuits which provide the 5 VDC and 12 VDC supply to the IC-1. Regulator IC-2 and IC-3 are used to get 5V and 12V supply respectively. The IC-1 will work in the actable multi vibrator mode. To work it in actable multi vibrator mode we need an external capacitor which is connected between the pin 1 and pin 3. Pin 2 is connected by the resistor to get the desired output frequency of the IC. The pins 10 and 11 are connected to the gate of the MOSFETS. The pin 10 and 11 are Q and ˜Q from these pins the output frequencies is generated with 50% duty cycle.

The output is connected to the MOSFETS through resistor which will help to prevent to the loading of the MOSFETS. The main AC Voltage is generated by the two MOSFETS which will act as a two electronic switches. The battery current is made to flow upper half or positive half of the primary coil of transformer, this is done when the pin 10 becomes high and lower half or negative half is done by opposite current flow through the primary coil of transformer.

Thus, we get 8 V AC voltage at the output of IC-1 .This 8V AC is given to the step up transformer of the Primary coil from this coil only we will get the increased 350V AC voltage, of the secondary coil this AC voltage is so high; from step up transformer we will get the max voltage. This 350V AC is converted into 350V DC through Bridge rectifier, which is used 4 numbers of diode. Thus at the final output we have received is 350V DC.

Note—if we change the transformer capacity, value and Electronic Component values, thus we can achieve more or less than 350 Volts@less current of 20 mA

### Results

### Without Implementing the Charging of Polarized Air Arrangement—Test Results

TABLE 1
IP, BP & FP

| Speed (rpm) | Load (kg) | IP (kW) | BP (kW) | FP (kW) |
|---|---|---|---|---|
| 1541.00 | 0.33 | 3.65 | 0.10 | 3.55 |
| 1471.00 | 3.01 | 3.34 | 0.84 | 2.50 |
| 1422.00 | 6.12 | 3.86 | 1.65 | 2.21 |
| 1402.00 | 9.02 | 4.55 | 2.40 | 2.14 |
| 1400.00 | 12.02 | 4.95 | 3.20 | 1.75 |

TABLE II
IMEP, BMEP& FMEP

| Speed (rpm) | Load (kg) | IMEP (bar) | BMEP (bar) | FMEP (bar) |
|---|---|---|---|---|
| 1541.00 | 0.33 | 4.29 | 0.11 | 4.18 |
| 1471.00 | 3.01 | 4.12 | 1.04 | 3.08 |
| 1422.00 | 6.12 | 4.93 | 2.11 | 2.82 |
| 1402.00 | 9.02 | 5.88 | 3.11 | 2.77 |
| 1400.00 | 12.02 | 6.41 | 4.14 | 2.26 |

TABLE III
Air & Fuel Flow

| Speed (rpm) | Load (kg) | Air (mmWC) | Fuel (cc/min) |
|---|---|---|---|
| 1541.00 | 0.33 | 39.80 | 7.00 |
| 1471.00 | 3.01 | 40.04 | 9.00 |
| 1422.00 | 6.12 | 39.02 | 12.00 |
| 1402.00 | 9.02 | 39.55 | 14.00 |
| 1400.00 | 12.02 | 39.87 | 18.00 |

TABLE IV
Indicated & Brake Thermal Efficiency

| Speed (rpm) | Load (kg) | IThEff (%) | BThEff (%) |
|---|---|---|---|
| 1541.00 | 0.33 | 89.65 | 2.34 |
| 1471.00 | 3.01 | 63.92 | 16.11 |
| 1422.00 | 6.12 | 55.39 | 23.73 |
| 1402.00 | 9.02 | 55.88 | 29.56 |
| 1400.00 | 12.02 | 47.29 | 30.58 |

TABLE V
SFC & Fuel Consumption

| Speed (rpm) | Load (kg) | SFC (kg/kWh) | Fuel (kg/h) |
|---|---|---|---|
| 1541.00 | 0.33 | 3.66 | 0.35 |
| 1471.00 | 3.01 | 0.53 | 0.45 |
| 1422.00 | 6.12 | 0.36 | 0.60 |
| 1402.00 | 9.02 | 0.29 | 0.70 |
| 1400.00 | 12.02 | 0.28 | 0.90 |

TABLE VI
TORQUE, Mechanical & Volumetric Efficiency

| Speed (rpm) | Load (Kg) | Torque (Nm) | Mech Eff. (%) | Vol Eff. (%) |
|---|---|---|---|---|
| 1541.00 | 0.33 | 0.59 | 2.61 | 57.23 |
| 1471.00 | 3.01 | 5.47 | 25.20 | 60.14 |
| 1422.00 | 6.12 | 11.11 | 42.84 | 61.41 |
| 1402.00 | 9.02 | 16.38 | 52.91 | 62.71 |
| 1400.00 | 12.02 | 21.82 | 64.66 | 63.05 |

TABLE VII

| | | Horse Power (H.P) |
|---|---|---|
| Speed | Torque | RPM × Torque/5252 |
| 1541.00 | 0.59 | 0.173 |
| 1471.00 | 5.47 | 1.53 |
| 1422.00 | 11.11 | 3.00 |
| 1402.00 | 16.38 | 4.37 |
| 1400.00 | 21.82 | 5.81 |

Note;
In order to calculate Horse Power we multiply RPM and torque at different load.

### With Implementation of the Charging of Polarized Air Arrangement as Herein Disclosed.—Test Results

TABLE VIII
IP, BP & FP

| Speed (rpm) | Load (kg) | IP (kW) | BP (kW) | FP (kW) |
|---|---|---|---|---|
| 1487.00 | 0.43 | 5.03 | 0.12 | 4.90 |
| 1458.00 | 3.33 | 5.16 | 0.92 | 4.24 |
| 1434.00 | 6.31 | 5.52 | 1.72 | 3.80 |
| 1427.00 | 9.30 | 5.46 | 2.52 | 2.94 |
| 1391.00 | 12.18 | 5.77 | 3.22 | 2.55 |

TABLE IX
IMEP, BMEP& FMEP

| Speed (rpm) | Load (kg) | IMEP (bar) | BMEP (bar) | FMEP (bar) |
|---|---|---|---|---|
| 1487.00 | 0.43 | 6.13 | 0.15 | 5.98 |
| 1458.00 | 3.33 | 6.43 | 1.15 | 5.28 |
| 1434.00 | 6.31 | 6.99 | 2.18 | 4.81 |
| 1427.00 | 9.30 | 6.94 | 3.21 | 3.74 |
| 1391.00 | 12.18 | 7.52 | 4.20 | 3.32 |

TABLE X
Air & Fuel Flow

| Speed (rpm) | Load (kg) | Air (mm WC) | Fuel (cc/min) |
|---|---|---|---|
| 1487.00 | 0.43 | 49.81 | 6.00 |
| 1458.00 | 3.33 | 50.10 | 8.00 |
| 1434.00 | 6.31 | 49.27 | 11.00 |
| 1427.00 | 9.30 | 48.81 | 14.00 |
| 1391.00 | 12.18 | 46.36 | 17.00 |

TABLE XI
Indicated & Brake Thermal Efficiency

| Speed (rpm) | Load (kg) | IThEff (%) | BThEff (%) |
|---|---|---|---|
| 1487.00 | 0.43 | 144.16 | 3.52 |
| 1458.00 | 3.33 | 111.10 | 19.83 |
| 1434.00 | 6.31 | 86.43 | 26.91 |
| 1427.00 | 9.30 | 67.14 | 31.00 |
| 1391.00 | 12.18 | 58.37 | 32.59 |

TABLE XII
SFC & Fuel Consumption

| Speed (rpm) | Load (kg) | SFC (kg/kWh) | Fuel (kg/h) |
|---|---|---|---|
| 1487.00 | 0.43 | 2.44 | 0.30 |
| 1458.00 | 3.33 | 0.43 | 0.40 |
| 1434.00 | 6.31 | 0.32 | 0.55 |
| 1427.00 | 9.30 | 0.28 | 0.70 |
| 1391.00 | 12.18 | 0.26 | 0.85 |

TABLE XIII
TORQUE, Mechanical & Volumetric Efficiency

| Speed (rpm) | Load (Kg) | Torque (Nm) | Mech Eff. (%) | Vol Eff. (%) |
|---|---|---|---|---|
| 1487.00 | 0.43 | 0.79 | 2.44 | 66.36 |
| 1458.00 | 3.33 | 6.04 | 17.85 | 67.87 |
| 1434.00 | 6.31 | 11.45 | 31.13 | 68.43 |
| 1427.00 | 9.30 | 16.87 | 46.18 | 68.45 |
| 1391.00 | 12.18 | 22.10 | 55.83 | 68.44 |

TABLE XIV

| | | Horse Power (H.P) |
|---|---|---|
| Speed | Torque | RPM × Torque/5252 |
| 1487.00 | 0.79 | 0.22 |
| 1458.00 | 6.04 | 1.676 |
| 1434.00 | 11.45 | 3.12 |
| 1427.00 | 16.87 | 4.58 |
| 1391.00 | 22.10 | 5.85 |

### Results and Discussion

TABLE XV

| | Without apparatus | With Apparatus |
|---|---|---|
| Load | Horse Power H.P | Horse Power H.P |
| 0.43 | 0.173 | 0.22 |
| 3.33 | 1.53 | 1.676 |
| 6.31 | 3.00 | 3.12 |
| 9.30 | 4.37 | 4.58 |
| 12.18 | 5.81 | 5.85 |

TABLE XVI

| Load | Horse Power H.P Increase Percentage |
|---|---|
| 0.43 | 21.36% |
| 3.33 | 8.71% |
| 6.31 | 3.84% |
| 9.30 | 4.58% |
| 12.18 | 0.68% |

TABLE XVII
SFC

| SFC (kg/kWh) | | |
|---|---|---|
| WITHOUT | SFC (kg/kWh) | SFC (kg/kWh) |
| APPRATUS | WITH APPRATUS | IN PERCENTAGE |
| 3.66 | 2.44 | 33.34% |
| 0.53 | 0.43 | 18.86% |
| 0.36 | 0.32 | 11.11% |
| 0.29 | 0.28 | 3.44% |
| 0.28 | 0.26 | 7.14% |

### Pollution Table—This Pollution Data is Generated in BSIII VCR (Variable Compression Ratio) Kirloskar Diesel Engine Genset

TABLE XVIII
Without Apparatus Pollution Graph

| Emission | 0 Kg | 3 Kg | 6 Kg | 9 Kg | 12 Kg |
|---|---|---|---|---|---|
| CO | 0.07 | 0.07 | 0.06 | 0.05 | 0.05 |
| HC | 58 | 68 | 67 | 74 | 78 |
| CO2 | 1.9 | 2.6 | 3.4 | 4.1 | 5.7 |
| O2 | 17.74 | 16.49 | 15.3 | 14.16 | 12.21 |
| Smoke | 10.1 | 24.4 | 33.1 | 37.9 | 38 |

TABLE XIX
With Apparatus Pollution Graph

| Emission | 0 Kg | 3 Kg | 6 Kg | 9 Kg | 12 Kg |
|---|---|---|---|---|---|
| CO | 0.04 | 0.03 | 0.03 | 0.02 | 0.02 |
| HC | 44 | 49 | 45 | 50 | 58 |
| CO2 | 1.5 | 2.1 | 2.8 | 3.7 | 3.8 |
| O2 | 18.79 | 15.17 | 14.42 | 13.14 | 10.1 |
| Smoke | 3.4 | 15 | 24.5 | 28.44 | 31.21 |

TABLE XX
IP

| IP (kW) | IP (kW) | IP (kW) |
|---|---|---|
| WITHOUT | WITH | INCREASE |
| APPRATUS | APPRATUS | PERCENTAGE |
| 3.65 | 5.03 | 27.43% |
| 3.34 | 5.16 | 35.27% |
| 3.86 | 5.52 | 30.07% |
| 4.55 | 5.46 | 16.66% |
| 4.95 | 5.77 | 14.21% |

TABLE XXI

| IMEP (bar) | | |
|---|---|---|
| Without | | IMEP Increase |
| apparatus | IMEP (bar) | Percentage % |
| 4.29 | 6.13 | 30.01% |
| 4.12 | 6.43 | 35.92% |
| 4.93 | 6.99 | 29.47% |
| 5.88 | 6.94 | 15.27% |
| 6.41 | 7.52 | 14.76% |

TABLE XXII

| IThEff (%) | IThEff (%) | IThEff (%) Increase |
|---|---|---|
| Without Apparatus | With Apparatus | Percentage % |
| 89.65 | 144.16 | 37.81% |
| 63.92 | 111.10 | 42.46% |
| 55.39 | 86.43 | 35.91% |
| 55.88 | 67.14 | 16.77% |
| 47.29 | 58.37 | 18.98% |

The indicating power percentage is increased, that means the combustion volume is increase and subsequently burnt gas volume is decrease, the conclusion is entrap volume of combustion is change in this innovation for only every diesel engine vehicle.

TABLE XXIII

| Vol Eff. (%) | Vol Eff. (%) | Vol Eff. (%) |
|---|---|---|
| Without | With | Increase |
| Apparatus | Apparatus | Percentage |
| 57.23 | 66.36 | 13.75% |
| 60.14 | 67.87 | 11.38% |
| 61.41 | 68.43 | 10.25% |
| 62.71 | 68.45 | 8.38% |
| 63.05 | 68.44 | 7.87% |

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

I claim:

1. An arrangement for charging polarized atmospheric air (4) and polarized exhaust gas (7) simultaneously in internal combustion diesel engine (1) comprising of:
at least two polarizing cum filter mesh arrangement consisting of an inlet end and an outlet end; a cylindrical pipe; a plurality of pair of meshed discs as electrodes, insulating glasses; nylon rubber; a hose pipe (3,5) and a circuitry for providing DC power to the mesh disc electrodes;
wherein said one polarizing cum filter mesh arrangement is (4) connected at outlet of intercooler (6) and inlet of the internal combustion engine for charging polarized atmospheric air to said engine and another said polarizing cum filter mesh arrangement is connected between the exhaust end of the internal combustion diesel engine and outlet of the inter cooler for charging polarized exhaust gases again back to the said internal combustion diesel engine through said intercooler.

2. The arrangement for charging as claimed in claim 1, wherein forced polarized (air/exhaust) gas supply of the air is passed through a cylindrical pipe comprising of plural number of a pair of meshed discs being made up of a material selected from group consisting of copper, aluminium and steel alloys.

3. The arrangement for charging as claimed in claim 2, wherein said electrodes namely cathode and anode are alternatively placed, and the said meshed discs in such a way so as to provide a gap between each meshed disc and the each pair for sedimenting particulate matters, (it is working like a parallel plate capacitor having separation distance of 1 mm.

4. The arrangement for charging as claimed in claim 3, wherein said gap between two meshed discs is preferably 1 mm and the gap between the two pairs is 3 inches and the pair of such mesh discs is 5 and total number of meshed disc is 10, which is dependent on the horizontal space length.

5. The arrangement for charging as claimed in claim 2, wherein said each meshed disc is separated by insulating material like glass.

6. The arrangement for charging as claimed in claim 1, wherein said air pipe is made up of non-metal and preferably polyvinyl chloride or aluminium alloy, inner side of aluminium alloy is coated by non-conducting paint and is L-shaped.

7. The arrangement for charging as claimed in claim 1, wherein said electronic circuit device is configured for converting an input voltage of 12V DC to 130-250V DC; and
Where in the output voltage is dependent on the load capacity of Diesel Engine.

8. The arrangement for charging as claimed in claim 1, wherein the current passes through the meshed discs is 0.02-1.0 AMP. FIG. 5

9. The arrangement for charging as claimed in claim 1, wherein said electronic circuit device being fixed outside the apparatus (8,9) means to convert an input voltage of the electric source to an output voltage for charging the connected electrodes meshed discs;
Where in the said pair meshed discs being arranged with gap between each adjacent disc where in the each of said adjacent disc being charged with alternative potential;
Wherein the said insulating material is placed between adjacent meshed discs in such a way that there is no obstruction is air flow through said discs.

10. An arrangement for charging polarized atmospheric air (4) and polarized exhaust gas (7) simultaneously in internal combustion diesel engine comprising of:
at least two polarizing cum filter mesh arrangement (4,7) consisting of an inlet end and an outlet end; a cylindrical pipe; a plurality of pair of meshed discs as electrodes; insulating glasses; nylon rubber; a hose (3,5) pipe and a circuitry for providing DC power to the mesh disc electrodes;
wherein said one polarizing cum filter mesh arrangement is connected at outlet of intercooler and inlet of the internal combustion engine FIG. 1a for charging polarized atmospheric air (4) to said engine and another said polarizing cum filter mesh arrangement is connected between the exhaust end of the internal combustion diesel engine and inlet of the and internal combustion Diesel Engine configured for parallelly charging polarized exhaust gases (7) and polarized atmospheric air from intercooler into internal combustion diesel engine.
